(19) United States
(12) Patent Application Publication
(10) Pub. No.: US 2025/0317846 A1
(43) Pub. Date: Oct. 9, 2025

(54) POWER EFFICIENCY FOR ACCESS POINT

(71) Applicant: HEWLETT PACKARD ENTERPRISE DEVELOPMENT LP, Spring, TX (US)

(72) Inventors: Jianpo Han, Beijing (CN); Berend Dunsbergen, Santa Clara, CA (US); Jiaqi Li, Beijing (CN); Yu Jun, Beijing (CN); Liao Xu, Beijing (CN)

(21) Appl. No.: 18/628,252

(22) Filed: Apr. 5, 2024

(51) Int. Cl. H04W 52/02; H04W 52/24

(52) U.S. Cl. CPC H04W 52/0206; H04W 52/245

(57) ABSTRACT

In implementations of the present disclosure, there is provided an approach for saving power for an AP. A method comprises receiving a first signal from a station in connection with the AP. Then, a signal strength of the received first signal is detected. The detected signal strength is used to determine a signal strength range from a plurality of signal strength ranges, including the signal strength. Next, a transmit power corresponding to the selected signal strength range is determined according to a mapping between the plurality of signal strength ranges and a plurality of transmit powers and. Then, the determined transmit power is used to transmit a second signal to the station. Implementations of the present disclosure can reduce the transmit power of the AP when the signal strength of a signal from the station is greater, thereby saving power.

### BACKGROUND

Power efficiency is using less energy to provide the same amount of useful output from a service. It may be implemented by minimizing power consumption under equivalent service conditions. High power efficiency devices consume notably less electricity when operating under the same circumstances, which makes them more energy-efficient. For instance, an efficient appliance or electronic device can accomplish the same tasks as its traditional counterpart while significantly reducing overall energy consumption.

Access Points (APs) are critical components in wireless networks that facilitate client connectivity to a wired network infrastructure. In general, the APs have high bandwidth. Their power consumption varies based on several factors, including radio frequency (RF) transmission power, a number of connected clients, supported data rates, and hardware's inherent efficiency. Thus, Power efficiency is a very important aspect of the AP design.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures.

FIG. 1 illustrates a block diagram of an example environment in which reference implementations of the present disclosure may be implemented;

FIG. 2 illustrates an example of transmit power control according to implementations of the present disclosure;

FIG. 3 illustrates an example of power control for a moving station according to implementations of the present disclosure;

FIG. 4 illustrates an example of determining a transmit power according to implementations of the present disclosure;

FIG. 5 illustrates an example of scene-aware power saving according to implementations of the present disclosure;

FIG. 6 illustrates another example of scene-aware power saving according to implementations of the present disclosure;

FIG. 7 illustrates a flow chart of an example method for saving power according to implementations of the present disclosure; and

FIG. 8 illustrates an example access point device according to implementations of the present disclosure.

### DETAILED DESCRIPTION

As discussed above, power efficiency is an important aspect in the AP design. Traditional AP design primarily focuses on high bandwidth, with little attention paid to AP power consumption. Therefore, many APs have traditionally operated with relatively high power consumption. The APs contribute to the high energy consumption of the edge network. Most APs emissions come from the use of electricity to provide power to the APs.

With growing awareness of energy conservation and advancements in technology, AP designs are now integrating power efficiency considerations. The green AP feature has saved energy during AP idle time. Intelligent power monitor (IPM) features address the issue that power supply through power over Ethernet (POE) cannot meet hardware (HW) requirements. However, the energy consumption of the APs is still very huge when the APs are running.

Therefore, implementations of the present disclosure propose a solution for reducing the power consumption of an AP when the AP is running. According to implementations of the present disclosure, the AP receives a first signal from a station after the station is connected to the AP. Then, the AP may perform detections to determine signal strength of the received first signal. After the signal strength is determined, the AP may select a signal strength range from a plurality of signal strength ranges, including the signal strength. Next, the AP further obtains a mapping between the plurality of signal strength ranges and a plurality of transmit powers and uses the mapping to determine a transmit power corresponding to the selected signal strength range. At last, the AP uses the determined transmit power to transmit a second signal to the station.

As discussed above, the AP uses a signal strength of a received signal to determine a corresponding transmit power. Therefore, for the AP, the transmit power may be adjusted when the signal strength of the received signal is changed. In this case, the transmit power may be reduced when the signal strength of a received signal is greater. Therefore, the AP may use the lower transmit power to transmit a signal to a station, rather than using the full power to transmit the signal to the station. Therefore, the power efficiency for the AP is improved and the power consumption for the AP can be reduced.

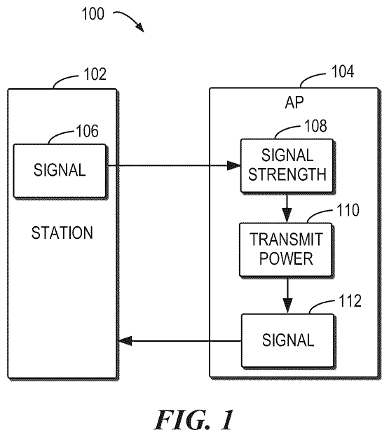

Other advantages of implementations of the present disclosure will be described with reference to the reference implementation as described below. Reference is made below to FIG. 1 through FIG. 8 to illustrate basic principles and several reference implementations of the present disclosure herein.

FIG. 1 shows a block diagram of an example environment in which reference implementations of the present disclosure may be implemented. In the example environment 100 of FIG. 1, an AP 104 may communicate with a station 102. FIG. 1 shows one station 102 communicating with the AP 104, which is only an example, rather than the limitation to the present disclosure. In some implementations, the AP 104 may communicate with a plurality of stations.

The station 102 is connected to the AP 104 and may transmit a signal 106 to the AP 104. After receiving the signal 106 from the station 102, the AP 104 may detect the signal strength of the received signal 106. For example, the AP 104 measures signal strength 108 by calculating a received signal strength indicator (RSSI) value of the received signal, which reflects an intensity of the received transmission. In some implementations, the signal strength of the received signal may represent the distance between the AP and the station. If the signal strength is smaller, it means that the station is farther away from the AP. On the contrary, if the signal strength is greater, it means that the station is closer to the AP.

Next, the AP 104 may use the signal strength 108 of the received signal to determine a transmit power 110. In this process, the AP 104 first determines a signal strength range from a plurality of signal strength ranges based on the signal strength. For example, the determined signal strength range includes the signal strength of the received signal. Additional, the plurality of signal strength ranges is predetermined.

Moreover, the AP 104 may obtain a mapping between a plurality of signal strength ranges and a plurality of transmit powers. In the mapping between a plurality of signal strength ranges and a plurality of transmit powers, a smaller signal strength range corresponds to a greater transmit power, and a greater signal strength range corresponds to a smaller transmit power. In some implementations, the AP 104 may obtain the mapping between a plurality of signal strength ranges and a plurality of transmit powers from other devices. In some implementations, the AP 104 may perform a test to determine the mapping between a plurality of signal strength ranges and a plurality of transmit powers.

In some implementations, in order to obtain the mapping between a plurality of signal strength ranges and a plurality of transmit powers, an in-house calibration may be performed. For example, a performance test for the AP may be performed at different ranges using different transmit power, and the most energy-efficient power at different signal strength ranges may be figured out. For example, a 500 Mbps performance test for the AP at different ranges using different transmit power may be performed. According to the performance test, the most energy-efficient power at different signal strength ranges may be determined. Through the above performance test, the mapping between a plurality of signal strength ranges and a plurality of transmit powers may be determined.

As discussed above, the AP 104 may further determine that the signal strength of the received signal belongs to which signal strength range of the plurality of signal strength ranges. After the signal strength range is determined, the AP 104 may search for a transmit power 110 corresponding to the signal strength range in the mapping between a plurality of signal strength ranges and a plurality of transmit powers.

The AP 104 further uses the transmit power 110 to send a signal 112 to the station 102. If the signal strength is greater, it means that the distance between the AP and the station is smaller. In this case, the AP 104 uses a smaller transmit power, rather than full power of the AP, to transmit a signal to the station, for example, using the reduced transmit power. Therefore, the power efficiency is improved, and the power saving is achieved. If the signal strength is smaller, it means that the distance between the AP and the station is larger. In this case, the AP 104 uses the greater transmit power to transmit signal to the station, for example, using the full transmit power.

Additionally, a run-time calibration may be performed using a link measurement mechanism. This operation can solve hardware differences between the AP and the AP under test. With the above operations, it may guarantee that signals on the client side can meet sensitivity requirements and performance is not impacted. For example, if the AP 104 transmits the signal 112 to a station using the transmit power 110, and the received signal in the station cannot meet the sensitivity requirement, the transmit power 110 will be adjusted to make sure that the station 102 may correctly receive the signal 112. For example, the transmit power 110 is increased, and the AP 104 uses the increased transmit power to retransmit the signal to the station.

FIG. 1 describes the process for determining transmit power for one station. If there are a plurality of stations, the AP 104 may receive signals from the plurality of stations and may determine respective transmit power corresponding to each of the plurality of stations.

Therefore, through the above operations, the AP may determine a signal strength of a received signal and a signal strength range, including the signal strength. The AP may further adjust a transmit power based on the signal strength range. Therefore, the transmit power may be reduced when the signal strength of a received signal is greater. Thus, the AP may use the reduced transmit power to transmit a signal to a station, rather than using the full power to transmit the signal to the station. Thereby, the power efficiency for the AP is improved and the power consumption for the AP can be reduced.

In some implementations, in order to further reduce the power consumption of the AP, the AP 104 also selects a working mode from a plurality of working modes based on the working load for the AP. In a light load scenario, the AP 104 may work in a standby mode or a light traffic mode. In this case, the AP 104 may reduce chains between the AP and the station, and reduce channel width and Ethernet speed. In a medium or high load scenario, the AP 104 may work in a single-user (SU) mode or a SU and remote client mode. In this case, the AP 104 may reduce chains between the AP and the station, and reduce transmit power for nearby clients. Additionally, for the remote clients, the transmit chains may be reduced and the stream beamforming is used. In a high load scenario, the AP 104 may work in a multi-user (MU) mode. In this case, the AP 104 may reduce transmit power for nearby clients.

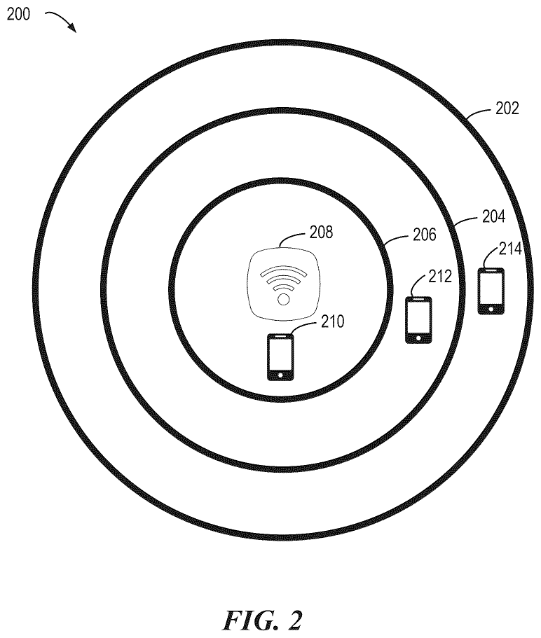

FIG. 2 shows an example 200 of transmit power control according to implementations of the present disclosure. In the example 200, there is an AP 208 and three stations 210, 212, and 214 connected to the AP 208. A space around the AP 208 is divided into three areas, or the signal strength for the AP 208 is divided into three ranges: a first area or a first range 206, a second area or a second range 204, and a third area or a third range 202.

In the example 200, the three areas or the three ranges correspond to three different transmit powers. The third area or the third range 202 corresponds to a full transmit power. The transmit power in the first area or the first range 206 is the smallest. When the three stations 210, 212, and 214 communicate with the AP 208, the AP 208 may detect the signals from the three stations 210, 212, and 214. Then, the AP may determine the signal strengths of signals from the three stations 210, 212, and 214. According to the signal strengths of signals, the AP 208 may determine the range that the signal of each of the three stations belongs to, or the area where the station is located. Then, the AP 208 may determine the respective transmit power corresponding to each of the three stations based on a mapping between the plurality of ranges and a plurality of transmit powers. Therefore, the AP 208 may use different transmit powers to transmit signals to the different stations.

As shown in FIG. 2, the AP 208 uses the smallest transmit power to transmit signals to the station 210 and uses the middle transmit power to transmit signals to the station 212. Compared with using the full transmit power to transmit signals to each station, the power saving is achieved. Moreover, FIG. 2 shows that there are three stations and three areas or three ranges, which is an example, rather the limitation the disclosure. In some implementations, there are any number of stations communicating with the AP, and the area or the range around the AP may be divided into any number of areas or ranges.

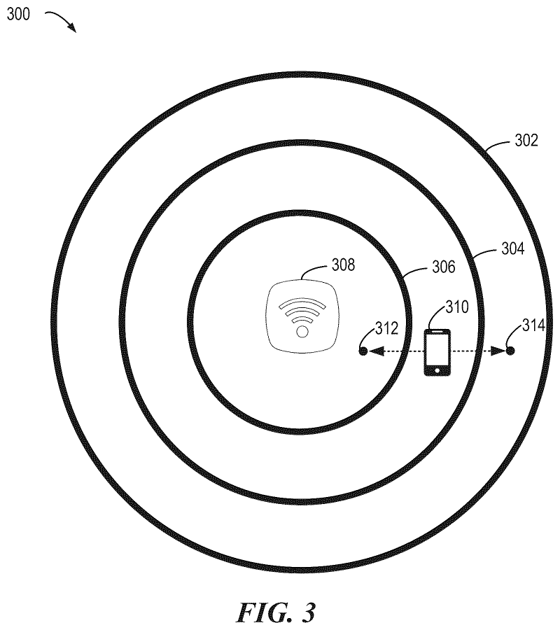

FIG. 3 shows an example 300 of power control for a moving station according to implementations of the present disclosure. In the example 300, there is an AP 308 and one station 310 connected to the AP 308. A space around the AP 308 is divided into three areas, or the signal strength of the AP 308 is divided into three ranges: a first area or a first range 306, a second area or a second range 304, and a third area or a third range 302.

As shown in FIG. 3, the AP 308 receives a signal from the station 310 and determines that a signal strength of the received signal belongs to the second area or the second range 304. Therefore, the AP 308 uses a transmit power corresponding to the second area or the second range 304 to send signals to the station 310. The station 310 may move to the area around the AP 308. If the station 310 moves to the point 312 in the first area or the first range 306, the AP 308 may further measure the signal from the station 310. Because that the station 310 moves closer to the AP 310, the signal strength becomes greater, and the AP may use the transmit power corresponding to the first area or the first range 306 to transmit signals to the station 310. In this case, the transmit power for the station is reduced.

Moreover, if the station 310 moves to the point 314 in the third area or the third range 302, the AP 308 may further measure the signal from the station 310. Because that the station 310 moves away from the AP 310, the signal strength becomes smaller, and the AP may use the transmit power corresponding to the third area or the third range 302 to transmit signals to the station 310. Therefore, the transmit power of the station is updated once the station moves. In this case, the transmit power for the station is increased.

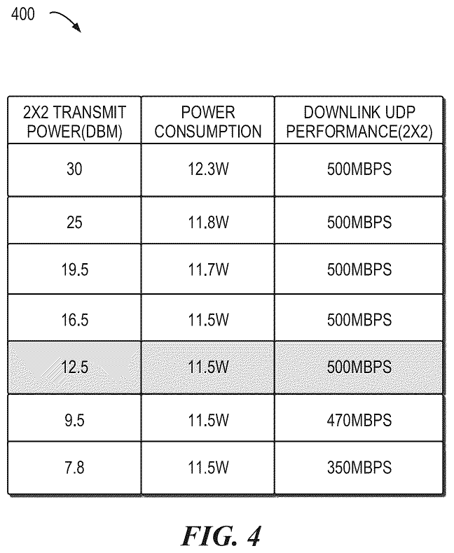

Moreover, the mapping includes a plurality of signal strength ranges and a plurality of transmit powers. The process for establishing the mapping between a plurality of signal strength ranges and a plurality of transmit powers includes two steps. In a first step, in-house calibration is performed. An AP-client performance test at different range may be performed by using different transmit power. Finally, the most energy efficient power at different signal range can be figured out. This stage can coarsely work in most scenarios. FIG. 4 shows an example 400 of determining a transmit power according to implementations of the present disclosure. As shown in example 400, different transmit powers are used to transmit data. In order to maintain the downlink user datagram protocol (UDP) performance being 500 mbps, the least transmit power for a signal range is determined, for example 12.5 dbm.

Considering the diversity of scenarios and differences in devices, there might be 1˜2 dB offset between user scenario and reference scenario, so need an auto run-time calibration to compensate for this offset. Therefore, in a second step, a run-time calibration is performed. Using link measurement mechanism, the AP can determine signal strength at station side and also determine path loss and client antenna gain. If signal at station side cannot meet the current rate's sensitivity requirement, the AP can slightly adjust transmit power.

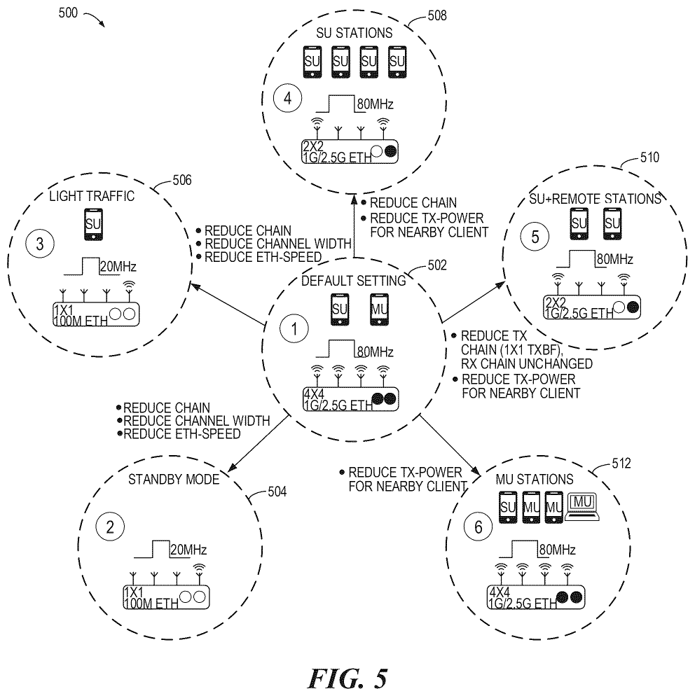

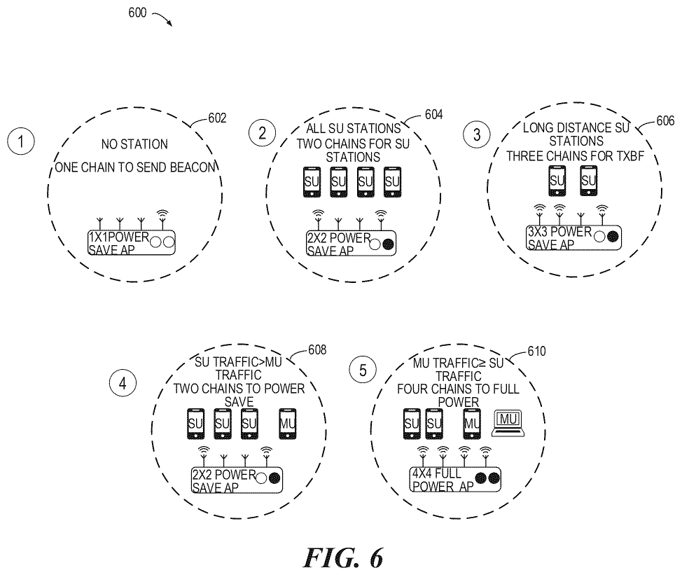

The above contents describe that the AP may determine the transmit power according to the signal strength of the station communicate with station. Additionally or alternatively, the AP may further determine to working mode of the AP. Next, the selection of the working mode for the AP may be described with reference to FIG. 5 and FIG. 6.

FIG. 5 shows an example 500 of scene-aware power saving according to implementations of the present disclosure. In example 500, a default setting mode 502 for the AP means when there are both single-user (SU) stations and multi-user (MU) stations connected to the AP. The SU station supports SU-multiple-input multiple-output (MIMO), and the MU station supports MU-MIMO. In the default setting mode 502, hardware is set to maximum capability, whether necessary or not. For example, 1G/2.5G Ethernet, 80M channel width, and 4×4 MIMO are used in the default setting mode 502. This mode has the highest power consumption and wastes power.

In this disclosure, if no station is connected to the AP, the AP may use standby mode 504. In the standby mode, core hardware components are set to have the least capability. For example, chains for the AP are reduced, and a single chain is used. Moreover, the channel width is reduced to be 20M, and 1G/2.5G Ethernet is reduced to 100M Ethernet. Although, the device is running in low power mode, however, it's ready for any upcoming new connection from either 2.4G or 5G wireless stations.

If there is a set of stations connected to the AP, the AP may further determine the load of the AP caused by the set of stations. In some implements, the load of the AP includes a number of the set of stations and traffic volume caused by the set of stations. In some implementations, the AP may use the number of the set of stations and the traffic volume caused by the set of stations to determine the working mode of the AP. In this case, the AP may determine whether the number is less than a threshold number, and the traffic volume is less than a threshold traffic volume.

If the AP determines that the number of the set of stations is less than a threshold number, and the traffic volume for the AP caused by the set of stations is less than a threshold traffic volume, a light traffic mode 506 is used by the AP. Similar to the standby mode, core hardware components are set to have the least capability to meet light traffic requirements. For example, chains for the AP are reduced, and a single chain is used. Moreover, the channel width is reduced to 20M, and 1G/2.5G Ethernet is reduced to 100M Ethernet. Additionally, for the nearby stations, the transmission power may be reduced based on the transmit power control discussed above.

In some implementation, the AP may use the traffic volume caused by the set of stations to determine the working mode of the AP. The AP may determine whether the traffic volume is less than a threshold traffic volume. If the AP determines that the traffic volume is less than a threshold traffic volume, a light traffic mode 506 is used by the AP.

In some cases, the AP may determine that the light traffic mode 506 is not suitable. In some implementations, if the number of the set of stations is greater than or equal to the threshold number or the traffic volume caused by the set of stations is greater than or equal to the threshold traffic volume, the traffic mode 506 is not suitable. In some implementations, the traffic volume caused by the set of stations is greater than or equal to a threshold traffic volume, the traffic mode 506 is not suitable. Therefore, the AP may further determine which mode is suitable.

In this case, the AP may further determine that the traffic is dominated by SU stations or MU stations. For example, the AP may calculate a ratio of a traffic volume for the set of SU stations of the set of stations, such as using the traffic volume for the set of SU stations and the traffic for the set of stations to determine the ratio. If the AP determines that the ratio is greater than a threshold ratio, the AP may determine that the traffic is dominated by the SU stations. In contrast, If the AP determines that the ratio is smaller than or equal to a threshold ratio, the AP may determine that the traffic is dominated by the MU stations.

If the traffic for the AP is dominated by the SU stations, the SU mode 508 is used regardless of whether there is an MU station or not. In this case, the MU station may be adjusted to an SU station. Generally, the SU mode is used in middle/high load scenarios. In the SU stations mode 508, if the maximum number of streams of the SU station is 2, the chains for the AP are reduced, and 2×2 MIMO is used. Moreover, the transmit power is reduced for the nearby station according to the transmit power control discussed above. Therefore, the power consumed by these unnecessary chains can be saved.

Additionally, the AP may further determine where there is a remote station in the set of the stations. If there is a remote station in the set of the stations, the SU and remote stations mode 510 is used. For the nearby stations of the AP, the SU station mode is used. For a remote client, it is need to consider AP coverage issue. In the transmit direction, the transmit chains may be reduced and streams beamforming is used. For example, the transmit chains are reduced to 2 or 3 chains, so that 1 stream or 2 streams beamforming is used to enforce signals at the remote client side. In the receiving direction, all chains are enabled, so that it can benefit from Maximum Ratio Combining (MRC), and receiving sensitivity is not affected.

If it is determined that the traffic is dominated by the MU stations, the MU mode 512 is used. Generally, the MU mode is used in high load scenario, and this mode has the highest performance and power consumption. In this case, the transmit power for the nearby station is reduced according to the transmit power control discussed above to reduce AP's power consumption.

FIG. 6 shows another example 600 of scene-aware power saving according to implementations of the present disclosure. In this example 600, an AP supports 4×4 MIMO, and a number of streams supported by client is 2. In case 602, the AP uses a standby mode. If no client is connected to the AP, the chains for the AP are reduced, and one chain is left to save power. A case 604 is a SU case where all stations are the SU stations. In the SU case, two chains are used for all SU stations.

A case 606 is an SU beamforming case. If a client is far away from AP, the SU beamforming case is used, and the AP needs apply beamforming on this client, so it needs to increase one chain. A case 608 is a SU+MU case. In this SU+MU case, if traffic is dominated by SU clients, the unnecessary chains may be reduced to save power. A case 610 is an MU case. In this MU case, the traffic is dominated by MU clients. For example, the MU traffic is more than the SU traffic. In the MU case, all chains are used to communicate traffic between the AP and the SU stations, and the MU stations. When the chains for the AP are reduced to save power, MIMO information in the beacon is not undated. This is transparent to stations. Therefore, the AP can seamlessly switch among the above different cases without disconnecting stations.

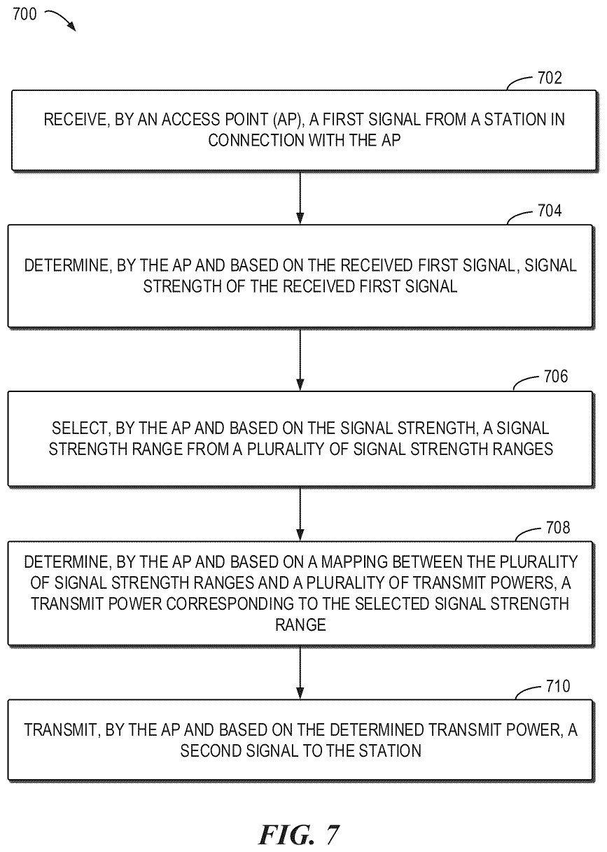

FIG. 7 illustrates a flow chart of an example method for saving power according to implementations of the present disclosure, and the method 700 is performed by an AP. At 702, the AP receives a first signal from a station in connection with the AP. For example, the station 102 is connected to the AP 104 and the AP 104 may receive a signal 106 from the station 102.

At 704, the AP determines, based on the received first signal, signal strength of the received first signal. For example, the AP 104 determines the signal strength of the received signal. The AP may calculate an RSSI value of the received signal to determine the signal strength. The signal strength for the signal from the station may represent the distance between the AP and the station. If the signal strength is greater, it shows that the station is closer to the AP. If the signal strength is smaller, it means that the station is farther away from the AP.

At 706, the AP selects, based on the signal strength, a signal strength range from a plurality of signal strength ranges. For example, the AP 102 may obtain a plurality of signal strength ranges which is predetermined. Next, the AP may compare the signal strength with the plurality of signal strength ranges to determine which signal strength range includes the signal strength. Therefore, the AP may find the signal strength range including the signal strength of the received signal.

At 708, the AP determines, based on a mapping between the plurality of signal strength ranges and a plurality of transmit powers, a transmit power corresponding to the selected signal strength range. For example, the mapping between the plurality of signal strength ranges and the plurality of transmit powers may be pre-established by performing in-house calibration. Then, the AP 104 may obtain the mapping, and use it to determine a transmit power corresponding to the selected signal strength range. For example, the AP may search for the selected signal strength range in the mapping, and then determine a transmit power corresponding to the selected signal strength range. In this case, if the signal strength is greater, the transmit power corresponding to the selected signal strength range is reduced because that the station is closer to the AP. If the signal strength is smaller, the transmit power corresponding to the selected signal strength range becomes greater because the station is farther away from the AP.

In some implementations, the AP 104 may obtain the mapping between a plurality of signal strength ranges and a plurality of transmit powers from the upper layer controller. In some implementations, the performance test is performed on the AP 104 to obtain the mapping between a plurality of signal strength ranges and a plurality of transmit powers. For example, a performance test for the AP may be performed at different ranges using different transmit power, and the most energy-efficient power at different signal strength ranges may be figured out. Through the above performance test, the mapping between a plurality of signal strength ranges and a plurality of transmit powers may be determined.

At 710, the AP transmits, based on the determined transmit power, a second signal to the station. As an example, the AP 104 transmits a signal 112 to the station by using the determined transmit power. In some implementations, the transmit power obtained from the mapping is a coarse transmit power. The coarse transmit power needs to be adjusted. Therefore, when the station 102 receives the signal 112, if the station cannot correctly recognize the signal or the received signal on the client side cannot meet sensitivity requirements, the signal may be retransmitted with an adjust transmit power, for example, an increased transmit power. Thus, it can solve hardware differences between the AP and the AP under test. With the above operations, it can guarantee that signals on the client side can meet sensitivity requirements and performance is not impacted.

In this way, the AP may determine a signal strength of a received signal and then determine a signal strength range, including the signal strength. The AP further determines a transmit power based on the signal strength range. Therefore, the transmit power may be reduced when the signal strength of a received signal is greater. Thereby, the power efficiency is improved, and the power consumption for the AP can be reduced.

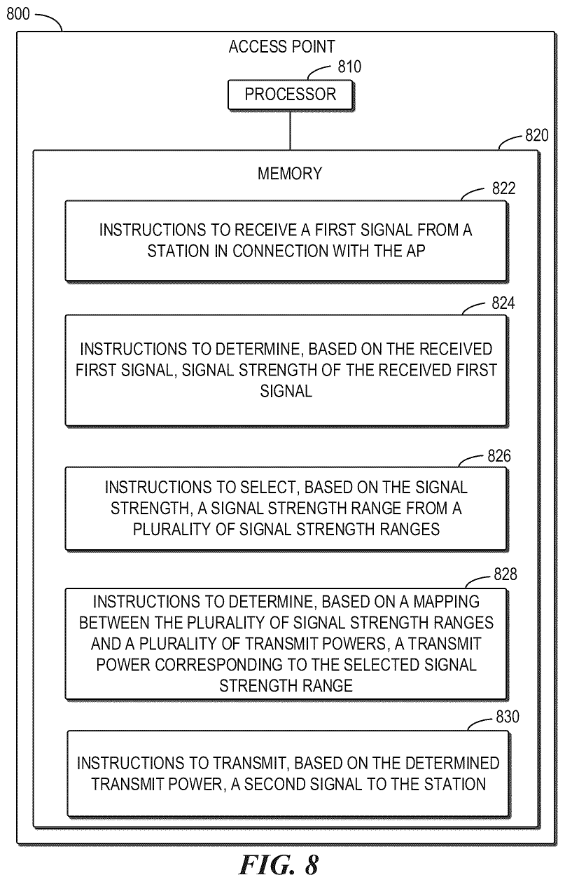

FIG. 8 illustrates an example AP 800 according to implementations of the present disclosure. As shown in FIG. 8, the AP 800 comprises at least one processor 810, and a memory 820 coupled to the processor 810. The memory 820 stores instructions 822, 824, 826, 828, and 830 to cause the processor 810 to perform actions according to reference implementations of the present disclosure.

As shown in FIG. 8, the memory 820 stores instructions 822 to receive a first signal from a station in connection with the AP. The memory 820 further stores instructions 824 to determine, based on the received first signal, signal strength of the received first signal. Moreover, the memory 820 further stores instructions 826 to select, based on the signal strength, a signal strength range from a plurality of signal strength ranges. The memory 820 further stores instructions 828 to determine, based on a mapping between the plurality of signal strength ranges and a plurality of transmit powers, a transmit power corresponding to the selected signal strength range. As shown in FIG. 8, the memory 820 further stores instructions 830 to transmit, based on the determined transmit power, a second signal to the station.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that from a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method comprising:
receiving, by an access point (AP), a first signal from a station in connection with the AP;
determining, by the AP and based on the received first signal, signal strength of the received first signal;
selecting, by the AP and based on the signal strength, a signal strength range from a plurality of signal strength ranges;
determining, by the AP and based on a mapping between the plurality of signal strength ranges and a plurality of transmit powers, a transmit power corresponding to the selected signal strength range; and
transmitting, by the AP and based on the determined transmit power, a second signal to the station.

2. The method according to claim 1, wherein transmitting the second signal to the station comprises:
determining that the second signal received by the station does not meet sensitivity requirements;
increasing the determined transmit power; and
retransmitting, based on the increased transmit power, the second signal to the station.

3. The method according to claim 1, further comprising:
determining that the station has moved relative to the AP; and
adjusting the determined transmit power based on a movement of the station.

4. The method according to claim 1, further comprising:
performing performance tests for the plurality of signal strength ranges by using a set of transmit powers; and
determining, based on the performance tests, a mapping between the plurality of signal strength ranges and the plurality of transmit powers of the set of transmit powers.

5. The method according to claim 4, further comprising:
determining that no station is connected to the AP; and
waiting for a connection from a new station by using a standby mode of the AP, a single chain being used and a channel width and an Ethernet speed being reduced in the standby mode.

6. The method according to claim 5, further comprising:
determining that a set of stations has been connected to the AP;
determining a load for the AP caused by the set of stations; and
determining a target working mode for the AP based on the load.

7. The method according to claim 6, wherein the load for the AP includes a number of the set of stations and a traffic volume for the AP caused by set of stations, and determining the target working mode for the AP based on the load comprises:
determining that the number is less than a threshold number, and the traffic volume is less than a threshold traffic volume; and
communicating traffic between the AP and the set of stations by using a light traffic mode, a single chain for the AP being used and a channel width and an Ethernet speed for the AP being reduced in the light traffic mode.

8. The method according to claim 7, wherein the set of stations includes a set of single-user (SU) stations and a set of multi-user (MU) stations, and determining the target working mode for the AP based on the load further comprises:
determining that the number is greater than or equal to the threshold number or the traffic volume is greater than or equal to the threshold traffic volume;
determining a ratio of a traffic volume for the set of SU stations of the set of stations;
determining that the ratio is greater than a threshold ratio; and
communicating traffic between the AP and the set of stations by using a SU mode, chains between the AP and the set of stations being reduced in the SU mode.

9. The method according to claim 8, wherein determining a target working mode for the AP based on the load further comprises:
determining that there is a remote station in the set of the stations; and
transmitting the traffic from the AP to the remote station by reducing chains for the AP and using stream beamforming.

10. The method according to claim 9, wherein determining a target working mode for the AP based on the load further comprises:
determining that the ratio is less than or equal to the threshold ratio; and
communicating traffic between the AP and the set of stations by using a MU mode of the AP, all chains for the AP being used in the MU mode.

11. An access point (AP) comprising:
at least one processor;
a memory coupled to the at least one processor, the AP working on a first channel, the memory storing instructions to cause the at least one processor to:
receive a first signal from a station in connection with the AP;
determine, based on the received first signal, signal strength of the received first signal;
select, based on the signal strength, a signal strength range from a plurality of signal strength ranges;
determine, based on a mapping between the plurality of signal strength ranges and a plurality of transmit powers, a transmit power corresponding to the selected signal strength range; and
transmit, based on the determined transmit power, a second signal to the station.

12. The AP according to claim 11, wherein the instructions to transmit the second signal to the station comprise instructions to cause the at least one processor to:
determine that the second signal received by the station does not meet sensitivity requirements;
increase the determined transmit power; and
retransmit, based on the increased transmit power, the second signal to the station.

13. The AP according to claim 11, the instructions further comprising instructions to cause the at least one processor to:
determine that the station has moved relative to the AP; and
adjust the determined transmit power based on a movement of the station.

14. The AP according to claim 11, the instructions further comprising instructions to cause the at least one processor to:
perform performance tests for the plurality of signal strength ranges by using a set of transmit powers; and
determine, based on the performance tests, a mapping between the plurality of signal strength ranges and the plurality of transmit powers of the set of transmit powers.

15. The AP according to claim 14, the instructions further comprising instructions to cause the at least one processor to:
determine that no station is connected to the AP; and
wait for a connection from a new station by using a standby mode of the AP, a single chain being used and a channel width and an Ethernet speed being reduced in the standby mode.

16. The AP according to claim 15, the instructions further comprising instructions to cause the at least one processor to:
determine that a set of stations has been connected to the AP;
determine a load for the AP caused by the set of stations; and
determine a target working mode for the AP based on the load.

17. The AP according to claim 16, wherein the load for the AP includes a number of the set of stations and a traffic volume for the AP caused by set of stations, and the instructions to determine a target working mode for the AP based on the load comprise instructions to cause the at least one processor to:
determine that the number is less than a threshold number, and the traffic volume is less than a threshold traffic volume; and
communicate traffic between the AP and the set of stations by using a light traffic mode, a single chain for the AP being used and a channel width and an Ethernet speed for the AP being reduced in the light traffic mode.

18. The AP according to claim 17, wherein the set of stations includes a set of single-user (SU) stations and a set of multi-user (MU) stations, and the instructions to determine a target working mode for the AP based on the load further comprise instructions to cause the at least one processor to:
determine that the number is greater than or equal to the threshold number or the traffic volume is greater than or equal to the threshold traffic volume;
determine a ratio of a traffic volume for the set of SU stations of the set of stations;
determine that the ratio is greater than a threshold ratio; and
communicate traffic between the AP and the set of stations by using a SU mode, chains between the AP and the set of stations being reduced in the SU mode.

19. The AP according to claim 18, wherein the instructions to determining a target working mode for the AP based on the load further comprise instructions to cause the at least one processor to:
determine that there is a remote station in the set of the stations; and
transmit the traffic from the AP to the remote station by reducing chains for the AP and using stream beamforming.

20. A non-transitory computer-readable medium comprising instructions stored thereon which, when executed by an access point (AP) working on a first channel, cause the AP to:
receive a first signal from a station in connection with the AP;
determine, based on the received first signal, signal strength of the received first signal;
select, based on the signal strength, a signal strength range from a plurality of signal strength ranges;
determine, based on a mapping between the plurality of signal strength ranges and a plurality of transmit powers, a transmit power corresponding to the selected signal strength range; and
transmit, based on the determined transmit power, a second signal to the station.
